(19) United States
(12) Patent Application Publication
(10) Pub. No.: US 2008/0243524 A1
(43) Pub. Date: Oct. 2, 2008

(54) System and Method for Automating Internal Controls

(75) Inventors: Rakesh Agrawal, San Jose, CA (US); Christopher Johnson, Oakland, CA (US); Gerald George Kiernan, San Jose, CA (US); Frank Leymann, Aidlingen (DE)

Correspondence Address: IP AUTHORITY, LLC;RAMRAJ SOUNDARARAJAN, 4821A Eisenhower Ave, Alexandria, VA, 22304, US

(73) Assignee: INTERNATIONAL BUSINESS MACHINES CORPORATION, Armonk, NY (US)

(21) Appl. No.: 11/692,842

(22) Filed: Mar. 28, 2007

(51) Int. Cl. G06Q 10/00

(52) U.S. Cl. 705/1

(57) ABSTRACT

A computer-based system and method to enforce, monitor, and assess internal controls over financial reporting is provided. A bottom-up approach is used to model transaction-control workflows using logs of past transaction activity executions. Past workflows are reconstructed from these logs and reconstruction rules. The transaction-control workflows are compared with these reconstructed past workflows to determine whether transactions are compliant with the internal controls.

### BACKGROUND OF THE INVENTION

1. Field of Invention

The present invention relates generally to the field of compliance with financial laws and accounting regulations. More specifically, the present invention is related to enforcement, monitoring and assessment of internal controls over financial reporting.

2. Discussion of Prior Art

The Sarbanes-Oxley Act brought about extensive accounting reforms designed to increase the transparency of financial reporting under United States securities laws. Sections 302 and 404 of the Act require most public companies reporting to the Securities and Exchange Commission (“SEC”) to implement systems of internal control over financial reporting. Under the act, management of each reporting company must periodically assess the effectiveness of these internal controls, obtain outside auditor's attestation of the control system, and certify the accuracy of its financial statements.

Section 302 of the Act obligates executive officers of reporting companies to certify the accuracy of the company's financial statements and verify that they have designed internal controls to ensure that they remain aware of all material financial information. Section 404 designates the SEC to adopt rules requiring each company's annual report to contain an internal control report, which must include (i) management's framework for evaluating internal controls; (ii) its assessment of the effectiveness of internal controls at the end of the fiscal year; and (iii) an outside auditor's attestation of management's assessment.

The SEC's Final Rule (“SEC Rule”) under Section 404 defines “internal control over financial reporting” as a process designed to provide reasonable assurance regarding the reliability of financial reporting and the preparation of financial statements in accordance with generally accepted accounting principals in the U.S. (“GAAP”).

The SEC Rule states that internal controls must include policies and procedures that pertain to maintenance of records that: (i) accurately and fairly reflect the company's transactions and dispositions of assets; (ii) assure that transactions are recorded as necessary to permit preparation of financial statements in accordance with GAAP; (iii) assure that receipts and expenditures of the company are being made only in accordance with authorizations of its management and directors; and (iv) reasonably assure prevention or timely detection of unauthorized acquisition, use or disposition of the company's assets that could have a material effect on the financial statements.

Since 2002, SEC-reporting companies have been designing and implementing internal controls to comply with the Sarbanes-Oxley Act. Most of these internal controls are enforced and monitored manually, consuming numerous employee hours and imposing a significant financial burden on reporting companies. Companies must design internal control systems that fit their specific operations and address their unique financial reporting risks. The controls are assigned to “owners” within the company who are responsible to track them. Additional time and labor is required to assess, document, and report on the effectiveness of internal controls. Automating some of these manual enforcement and assessment tasks would substantially reduce the cost of compliance.

There are many Sarbanes-Oxley software products currently on the market, such as, IBM's® Lotus Workplace for Business Controls, Microsoft's® Solution Accelerator for Sarbanes-Oxley, and OpenPages'™ Sarbanes-Oxley Express. These products provide controlled access to company financial data stored in content repositories. They also assist managers in organizing written control policies and risk assessments, and assigning control activities to owners within the company. Owners manually determine whether each control has been implemented and assessors periodically evaluate whether each control has been effective. Managers can view dashboards to determine status of each control. They can also generate reports to document results of these manual checks and control assessments.

Oracle's Internal Controls Manager and HandySoft's SOXA Accelerator also offer some conventional workflow modeling capabilities. Virsa's Continuous Compliance suite offers role-based access controls and real-time enforcement of certain access, authorization, and separation of duty controls. Although, these products provide assistance with Sarbanes-Oxley compliance, the enforcement and assessment of internal controls is still done manually. Hence, there is a need to develop technologies that automate real-time enforcement of control activities, provide more sophisticated modeling and auditing of transaction workflows, and proactive analysis of financial information.

U.S. patent application publication 2004/0260566 A1, assigned to Oracle International Corporation, describes an audit management workbench as part of a unified automated system of internal controls. The Oracle system allows managers to define required business processes, in a top-down fashion, through a graphical user interface. These business processes are then implemented through a workflow management system (WFMS), which includes workflow-enabled applications. The applications ensure that activities are executed in accordance with defined business processes. The Oracle system stores defined business processes and actual execution data for auditing purposes. The auditing system allows the audit manager to perform a variety of audit functions, including recovering past business processes, isolating sub-processes, verifying proper execution of separation of duty constraints, and evaluating business process elements against matching risks. The audit workbench also contains various assessment tools, such as ratio calculators, anomaly detectors, sampling methods, process control reports, and fraud detectors, although details regarding these tools are not provided.

U.S. patent application publication 2004/0260583 A1, assigned to Oracle International Corporation, is related to the 2004/0260566 application and describes a process certification management system. The process certification manager communicates certification requests to users, receives messages from users regarding certification of business process and/or sub-process, and modifies the certification status in accordance with the message. The process certification manager displays the certification status of business processes in a first view and the certification status of all sub-processes in a second view.

Oracle's audit management workbench/process certification system fails to provide at least the following features: (a) inductive bottom-up modeling of workflows; (b) use of database constraints for active enforcement of internal controls; (c) tracking of exceptions to defined business processes; (d) query-based auditing capabilities to allow flexible analysis of past activity executions; (e) details about anomaly or fraud detection (or any suggestion that either is accomplished using discovery-driven OLAP); and (f) methods for explaining detected anomalies.

Whatever the precise merits, features, and advantages of the above cited references, none of them achieves or fulfills the purposes of the present invention.

### SUMMARY OF THE INVENTION

A computer-based system to automate modeling and auditing of internal controls over financial reporting, the system comprising: a workflow modeling component to mine logs of past transaction activity executions to reconstruct past workflows using reconstruction rules, the reconstructed past workflows used as a baseline to model at least one transaction-control workflow; and a workflow auditing component to compare the reconstructed past workflows with the at least one transaction-control workflow to determine compliance with the internal controls.

A computer-based system to automate real-time enforcement, modeling and auditing of internal controls over financial reporting, the system comprising: a workflow modeling component to mine logs of past transaction activity executions to reconstruct past workflows using reconstruction rules, the reconstructed past workflows used as a baseline to model at least one transaction-control workflow; a workflow auditing component to compare the reconstructed past workflows with the at least one transaction-control workflow to identify violations to audit constraints; an active enforcement component to compare the past transaction activity executions with the at least one transaction-control workflow to identify exceptions in real time; and wherein the identification of violations to audit constraints and the identification of exceptions in real-time determine compliance with the internal controls.

A computer-based method to automate real-time enforcement, modeling and auditing of internal controls over financial reporting, the method comprising: (a) logging past transaction activity executions for workflows; (b) mining logs of the past transaction activity executions to reconstruct past workflows using reconstruction rules; (c) modeling at least one transaction-control workflow using the reconstructed past workflows as a baseline; (d) enforcing policy-based constraints to ensure that each of the past transaction activity executions complies with the at least one transaction-control workflow; (e) comparing the reconstructed past workflows with the at least one transaction-control workflow to identify violations to audit constraints; and wherein the steps (d) and (e) determine compliance with the internal controls.

An article of manufacture comprising a computer usable medium having computer readable program code embodied therein to automate real-time enforcement, modeling and auditing of internal controls over financial reporting, the medium comprising: (a) computer readable program code aiding in logging past transaction activity executions for workflows; (b) computer readable program code mining logs of the past transaction activity executions to reconstruct past workflows using reconstruction rules; (c) computer readable program code modeling at least one transaction-control workflow using the reconstructed past workflows as a baseline; (d) computer readable program code enforcing policy-based constraints to ensure that each of the past transaction activity executions complies with the at least one transaction-control workflow; (e) computer readable program code comparing the reconstructed past workflows with the at least one required workflow to identify violations to audit constraints; and wherein compliance with the internal controls is determined based on the enforcement of policy-based constraints in (d) and the identification of violations to audit constraints in (e).

### BRIEF DESCRIPTION OF THE DRAWINGS

FIG. 1 illustrates the overall internal control solution architecture, as per the present invention.

FIG. 2 illustrates an implementation of workflow modeling, workflow active enforcement, and workflow auditing functions of the internal control solution architecture, as per an embodiment of the present invention.

FIG. 3 illustrates architecture of the workflow active enforcement component, as per the present invention.

FIG. 4 illustrates architecture of the financial analytics module, as per the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The following are definitions of some terms that will be used throughout the specification and will assist in understanding the invention:

Transaction: A transaction is a set of activities comprising a business operation that generates an entry in the company's financial statements. An example of a transaction would be the entire process of filling a product order, from receipt of the original customer order through reporting the completed sale in the company's financial statements.

Activity: An activity is a self-contained task in the execution of a transaction. Each step in the order fulfillment transaction described above is an activity.

Workflow: A workflow (WF) consists of an ordered set of activities and is the means of executing a transaction.

Routine vs. Non-Routine: A routine transaction is executed with sufficient regularity within a company that it has a defined workflow, while a non-routine transaction is one that is not executed on a regular basis.

Material: Information is material if there is a substantial likelihood that a reasonable investor would consider it important in deciding whether to buy, hold or sell a security. For instance, a financial reporting inaccuracy that would have a de minimis effect on a company's reported income may nevertheless be material if it suggests fraudulent reporting practices.

Financial Statements: Financial statements include a company's balance sheet, income statement, cash flow statement, and other financial information filed with the Securities and Exchange Commission (SEC).

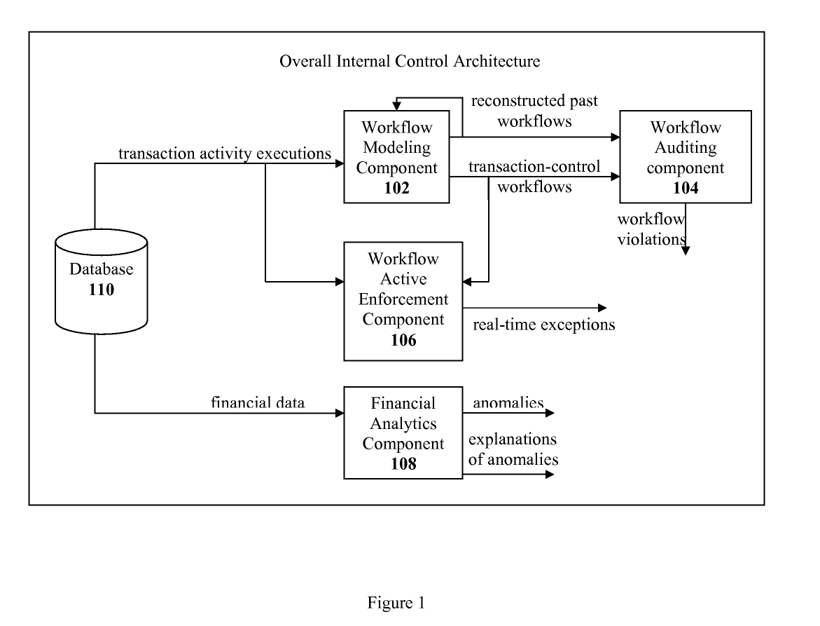

FIG. 1 illustrates the overall internal control architecture, as per the present invention. In a preferred embodiment the overall internal control architecture comprises a workflow modeling component and a workflow auditing component.

The workflow modeling component 102 employs a bottom-up approach, in which logs of actual past transaction activity executions stored as activity logs in database 110 are used to model transaction-control workflows rather than the conventional top-down approach, in which company personnel model workflows without regard to past executions or acceptable deviations from processes. The workflow modeling component uses logs of actual transactions to reconstruct past workflows, which are used as a baseline to model transaction-control workflows.

The workflow auditing component 104 performs workflow comparison between transaction-control workflows and reconstructed past workflows and outputs any material differences (exceptions) between the two workflows. The workflow auditing component also performs query-based auditing which uses queries and constraints to analyze logs of the reconstructed past workflows for specific insights.

Additionally, the overall internal control architecture includes a workflow active enforcement component 106 that ensures that routine transactions comply with prescribed transaction-control workflows. The active enforcement component 106 compares the transaction activities from activity logs (in database 110) with the transaction-control workflows to identify exceptions in real time and either halt the transaction or allow the transaction to proceed, while logging the exception for later auditing purposes.

Additionally, the overall internal control architecture is further comprised of a financial analytics component 108 that uses discovery-driven on-line analytical processing (OLAP) to identify financial anomalies, improprieties, fraud, and inaccuracies. The financial analytics component employs a discovery-driven approach, rather than a hypothesis-driven approach, to search financial information (stored in database 110) in data cubes for anomalies. This OLAP analysis uncovers potential anomalies in financial data that suggest accounting errors or improprieties.

OLAP cubes provide data operations such as drill-down, roll-up, and selection to uncover material data anomalies. However, standard OLAP methods rely on analysts to choose the proper search dimensions and data operations. This hypothesis-driven OLAP analysis is difficult given the large number of potential paths through the cube and often does not yield fruitful results due to the large volumes of data, multiple search dimensions, and cancellation effects that may obscure anomalies in lower-level data.

Instead of relying on analysts to select appropriate cube views, discovery-driven OLAP searches for indicators of anomalies in various levels of the data to guide further exploration. The present invention's method of identifying such indicators accurately reflects relevant business and financial metrics. The present invention's system also explains the relevance of the indicators in sufficient detail for an analyst to determine what additional cube views and data operations are necessary. Such analysis isolates meaningful anomalies in the financial data.

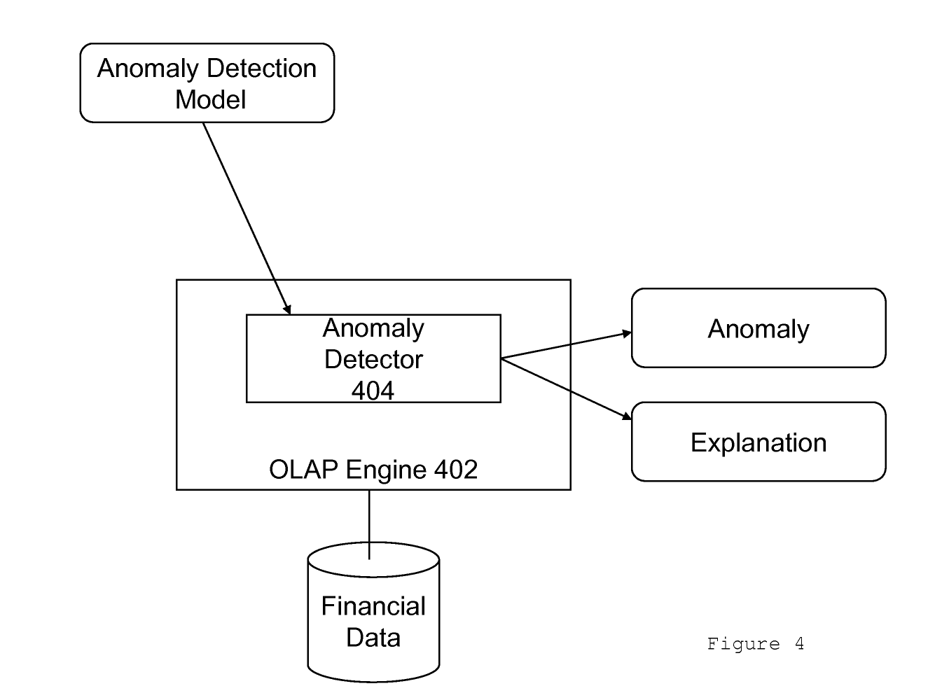

FIG. 4 illustrates architecture of the financial analytics module. An auditor submits an anomaly detection model to OLAP engine 402, which uses Anomaly Detector 404 to search cubes of financial data for indicators of anomalies. The model calculates the expected value for each cell in context of its position in the cube and its relation to trends along different dimensions to which the cell belong. If the value in a cell is significantly different than its expected value, it is identified as an anomaly. Anomaly Detector 404 then outputs any detected anomalies and explanations for why they are anomalous. This type of discovery-driven OLAP guides auditors to interesting or suspicious areas of the cube that they would not otherwise examine. Thus, it helps to discover inaccuracies and improprieties in the financial data that the auditor would not otherwise suspect (or find through hypothesis-driven OLAP).

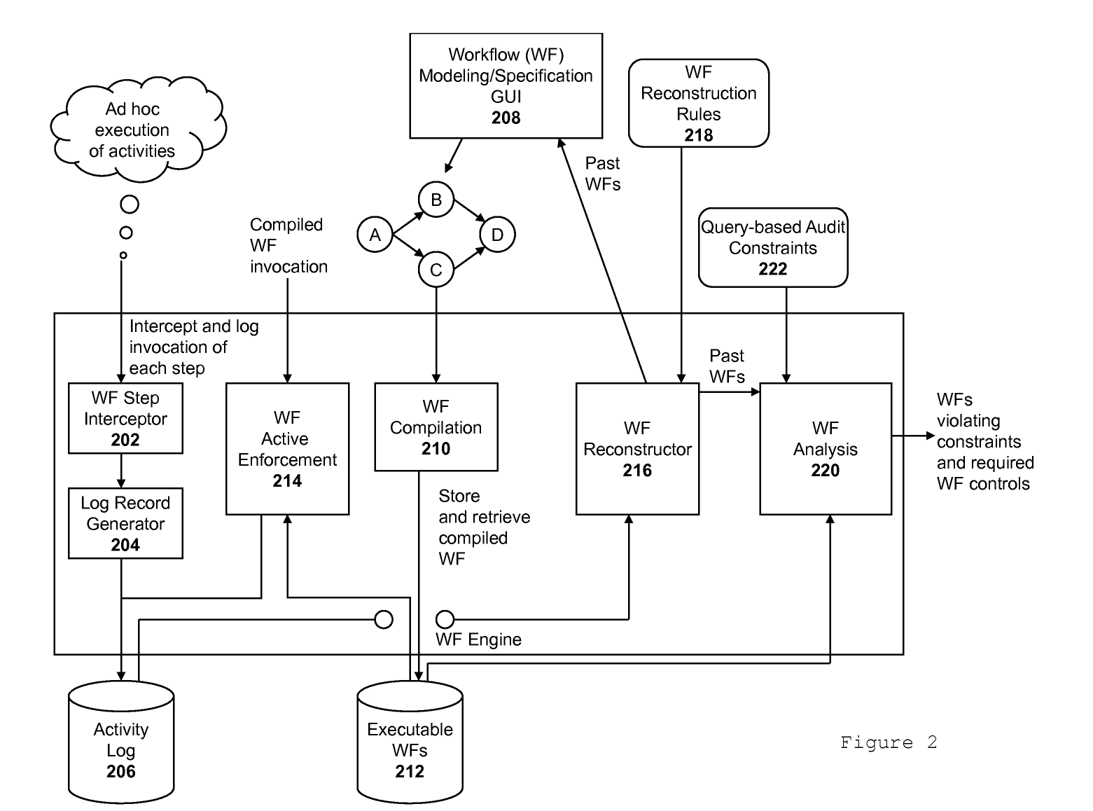

FIG. 2 illustrates an implementation of workflow modeling, active enforcement, and workflow auditing functions of the internal control solution architecture, as per one embodiment of the present invention. Workflow (WF) Step Interceptor module 202 intercepts actual activities (activity invocations in a workflow) and passes corresponding information to Log Record Generator module 204 that formats and stores the activity executions in Activity Log 206. Past transaction activity executions are recorded in activity logs that are stored in database tables. In general, activity executions include controls over initiating, authorizing, recording, processing, reporting significant accounts, disclosures, and related assertions in financial statements. The logs of these activity executions include the identity of a person who performed the activity, the date and time of execution, and any other relevant contextual information.

The WF Step Interceptor extends existing middleware components of various systems, to intercept activity invocations. The following are some examples of such middleware extensions and are not intended to limit the scope of the invention. In application server environments, a container hosting an executable activity may observe invocations of the activity and pass corresponding information to the Log Record Generator. Special deployment descriptor extensions may also allow such behavior to be declared for corresponding executables. Systems management environments could also be extended to intercept activity invocations based on new types of management events. In web service environments, policy annotations could be used to declare services as activities to be monitored. Such a policy annotation may result in corresponding SOAP (Simple Object Access Protocol) headers targeted at the Log Record Generator.

WF Reconstructor 216 draws logs of past transaction activity executions from activity log 206 and uses WF Reconstruction Rules 218 to reconstruct past workflows. Reconstruction rules assign individual activities to workflows. These rules may, for example, associate activities into a workflow based upon a unique workflow ID assigned to all activities in an individual workflow instance. Reconstruction rules may also be supported in an environment-specific manner. For instance, application servers may support deployment descriptors identifying elements of a signature of an invoked executable. Correlation properties and associated aliasing mechanisms may be used in web service environments to support correlation of individual activity invocations to workflow instances. Other rules may also reconstruct workflows by joining all activities performed on behalf of a specific user during a specified time.

The reconstructed past workflows are then passed on to WF Modeling/Specification GUI 208, where managers can review the past workflows for a particular transaction and add any additional activities or controls necessary to define a transaction-control workflow for that particular type of transaction. A transaction-control workflow incorporates internal controls over initiating, authorizing, documenting, processing, and reporting the transaction. Once the transaction-control workflow is defined in the GUI, it is passed on to WF Compilation module 210, which compiles the transaction-control workflow and stores it in the Executable WFs repository 212 in the form of database tables which are maintained for active enforcement and auditing purposes. The transaction-control workflows may be updated at any time and resubmitted for compilation.

Prior art WF modeling systems define workflows in a top-down fashion in which company personnel start by defining transaction-control workflows and then assure that subsequent transactions comply with these defined workflows. However, the present invention's modeling system uses a bottom-up process [202, 204, 206, 216, and 218] that uses reconstructed past workflows to establish the baseline for further definition of transaction-control workflows. Through this inductive, bottom-up process, company personnel can define transaction-control workflows that are acceptable to management, but actually account for the ways business is done within the company.

WF Active Enforcement component 214 imposes policy-based constraints on workflows at the time of execution. This component ensures that routine transactions comply with prescribed transaction-control workflows stored in Executable WFs repository 112. The WF Active Enforcement component compares the past transaction activity executions from activity log 206 with the transaction-control workflows from Executable WFs repository 212 to identify exceptions in real time. The WF Active Enforcement component can either halt the transaction or allow the transaction to proceed, while logging the exception for later auditing purposes.

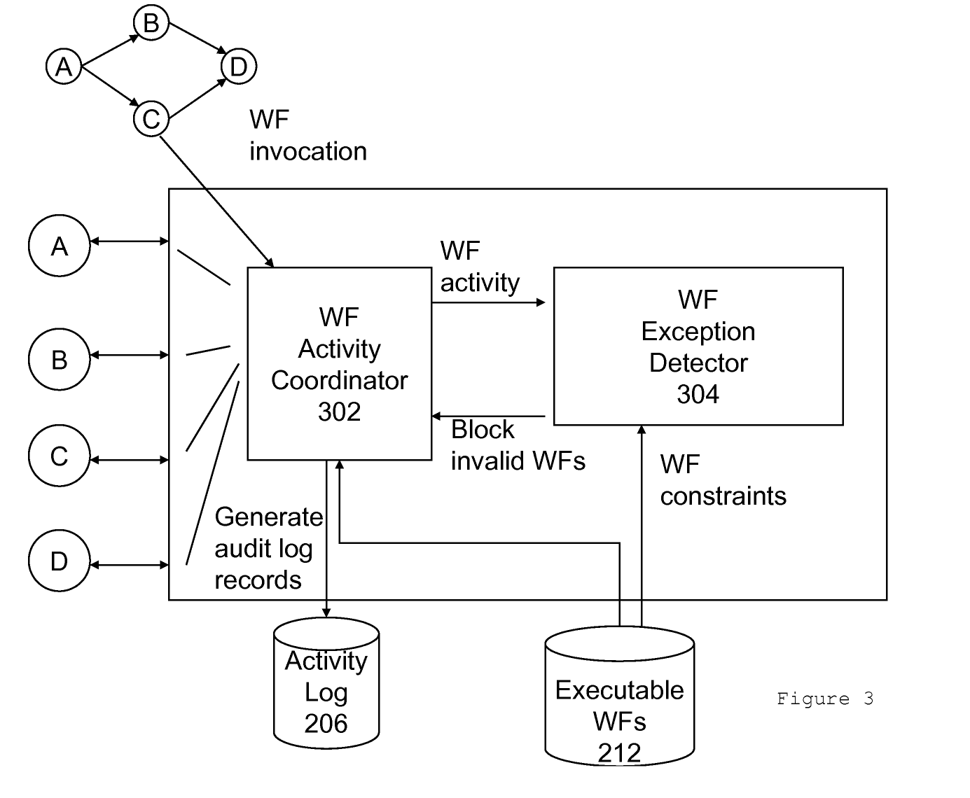

FIG. 3 illustrates the architecture of WF Active Enforcement component 214. Upon invocation of activities in a workflow, WF Coordinator 302 passes the activities onto WF Exception Detector 304, which determines whether each activity complies with the transaction-control workflow. If an activity is in violation, the WF Active Enforcement component blocks execution of further activities in the transaction. Examples of this type of enforcement include but are not limited to: authorization constraints in workflow management systems, secure co-processors verifying contract authorizations, and temporal database constraints. In an alternative embodiment, the WF Active Enforcement component allows the non-compliant transaction to proceed, but records the violation in activity log 106 which is maintained for audit purposes. This alternative embodiment avoids problems associated with enforcement errors and immaterial process deviations. Auditors may also use exception data gained from periodic audits to investigate violations and refine model workflows.

WF Analysis module 220 draws transaction-control workflows from the Executable WFs repository 212. The WF Analysis module 220 then draws reconstructed past workflows from the WF Reconstructor 216 and compares them with the transaction-control workflows. It then outputs any material differences (exceptions) between the past and transaction-control workflows. This is done on a transaction-by-transaction basis. The WF Analysis module 220 is able to distinguish between immaterial deviations in processes and actual breakdowns in the internal controls scheme. For instance, in many compliant transactions, activities and controls may be completed in different orders and substitute controls may also be acceptable. In addition, many past workflows may be compared to determine whether process deviations are systemic problems or isolated instances.

Query-based auditing enables companies to audit activity logs to investigate suspicious transactions and periodically assess the effectiveness of the internal control system. This query-based auditing capability allows auditors to formulate custom audit queries via an auditing GUI 222 using any standard query language. Auditors express the audits as queries with constraints against workflow instances. For example, if transactions over $1000 require approval of a second-line manager, the audit query may request all transactions over $1000 initiated by Adam between time t1 and t2 that were not approved by a second-line manager. The audit returns as its result instances of workflows that satisfy the defined constraints. Auditors can specify a wide variety of audit queries to investigate the activity logs.

Auditors analyze reconstructed past workflows using WF analysis module 220 to identify workflows that violate audit constraints specified by an auditor. For example, in the course of assessing internal controls, an auditor may want to investigate a suspicious manager by requesting an audit of all transactions approved by him or her or even all transactions executed within a certain time period. An auditor may also request an audit of all routine transactions executed within a specified timeframe that are non-compliant with the company's system of internal controls. Transaction-control workflows stored in Executable WFs repository 212 are input into WF Analysis module 220 for this purpose.

Described hereafter are non-limiting scenarios that describe the application of the internal control solution architecture of the present invention to various financial transactions involving a fictitious automotive parts company. In these scenarios, Rhone is a publicly-traded manufacturer and wholesaler of automotive parts that maintains a large inventory of parts for sale to distributors. The CEO has established an earnings growth target of 10% per year. Management's compensation is based on its ability to meet this target.

### 1) Routine Sales Transaction Scenario

In a typical Rhone sales transaction, a sales manager solicits orders from auto parts distributors. For each order, the sales manager prepares an electronic invoice, which is then forwarded to the shipping and accounts receivable departments. Upon receiving the invoice, the shipping department checks Rhone's inventory for the requested parts. If they are in stock, the invoice is forwarded to a shipping manager for approval. Upon receiving an approved invoice, the shipping desk fills the order and ships the parts. The accounts receivable department then mails a bill to the distributor. On the other hand, if the parts are not in stock, the shipping desk advises the distributor how long the order will take to fill. The distributor can elect to proceed, modify, or cancel the transaction. As soon as the parts leave the loading dock to be shipped to the distributors, an accountant records the total price of the order as revenue. Per accounting rules, the cost of goods sold is recognized on a per unit basis in the same period each unit is sold.

Workflow Auditing: Rhone would like to audit a particular sales transaction for which a distributor was billed, but never received delivery of the parts. To begin, a Rhone auditor specifies the transaction by invoice number and requests a workflow audit. Upon receipt of the audit request, Rhone's compliance auditing system uses activity logs to reconstruct the past workflow for that transaction. Comparing it to the transaction-control workflow, the system determines that a critical activity is missing. Although the transaction has been recorded as complete, the shipping clerk never confirmed shipment. Either the goods were never shipped or the clerk did not verify the shipment. Auditors can use this information to investigate whether the transaction was improperly recorded.

The auditor also uses the query-based auditing feature to determine whether there are similar transactions for which revenue was improperly recognized, but the shipment was not confirmed. This information will help the auditor determine whether this is a one-time occurrence or a systemic problem.

Active Enforcement: Such routine sales transactions are also amenable to active enforcement controls. In one instance, Rhone implements automated controls that would not allow routine transactions to proceed in the absence of a required activity. In the example above, the accountant would not be allowed to record the sale in the accounting ledgers until there was a confirmation of the shipment. As an alternative, the system allows the transaction to proceed, but logs the exception for later review by internal auditors.

Financial Analytics: Advanced OLAP analytics assists in detecting systemic problems in large numbers of routine transactions. For instance, a proactive OLAP audit reveals anomalies such as: (i) a period-to-period change in the ratio of recognized sales to confirmed shipments for a particular region; (ii) a significant increase in accounts receivable for sales generated by a particular sales manager; or (iii) a change in the ratio between orders and shipments for certain accounts. After detecting any of these anomalies, the auditor uses the workflow auditing features to investigate potential weaknesses in the internal control system.

### 2) Prevention and Detection of Fraud Scenarios

An important requirement of any internal control system is its ability to prevent or timely detect fraudulent accounting of transactions. The following are two scenarios in which Rhone uses fraudulent accounting methods to inaccurately inflate earnings.

Revenue Manipulation Scenario:—Susan is Vice-President of Sales for Rhone. Upon learning that Rhone is unlikely to meet its 10% earnings growth target for the first quarter, Susan encourages her sales managers to engage in aggressive tactics to increase revenues before the quarter end. Several managers enter into unwritten agreements with their distributors, wherein they will ship an extra 20% worth of parts. However, the account manager will not require payment for the extra parts unless and until the distributors are able to unload them to retailers. Using this scheme, the sales staff increases revenues and ensures that earnings targets are met for the quarter.

Workflow Auditing: An audit of past workflows reveals that the sales managers are submitting orders directly to the shipping desk without having verification or approval from a shipping manager. As soon as shipment of the goods is confirmed, Rhone recognizes the sales as revenue. However, Rhone does not receive payment for the goods unless and until they are sold to retailers, causing misleading earnings inflation due to swelling accounts receivable.

Active Enforcement: In one instance, Rhone could prevent these non-compliant transactions from proceeding by not allowing the shipment until the system receives invoice verification and shipping manager approval. Alternatively, the system could log records of these non-compliant transactions, which could be revealed and investigated in quarterly compliance audits. In either case, Rhone automatically detects this type of revenue manipulation early in the process.

Financial Analytics: In some situations, active enforcement and auditing would not reveal this revenue manipulation. For instance, the sales manager could produce fraudulent invoices for the additional orders and collude with a shipping manager to verify and approve these invoices. In this case, the analytics component would assist Rhone's internal auditors in uncovering the fraud. In comparing period-to-period financial data, OLAP analytics would uncover anomalous increases in accounts receivable and the ratio of accounts receivable to revenue and earnings. Further drill-down would allow internal auditors to isolate the sales and shipping managers with lower collection ratios associated with their invoices.

Cost Manipulation Scenario:—Again in the second quarter, Susan fears that Rhone will fail to meet its earnings target. This time, Susan approaches Carlos, the assistant controller, and asks him whether there is any slack in the company's accounting figures keeping earnings growth down for the quarter. Carlos determines that Rhone is incurring significant expense in its ongoing promotional campaign, whereby it ships free product samples to auto parts retailers and repair shops. Since this campaign is creating demand pull for Rhone's new products, Carlos decides that it can be categorized as a long-term customer acquisition cost rather than a period cost. As such, he capitalizes these expenses over the next ten years, rather than fully recognizing them in the current year. Accordingly, Rhone's costs are reduced and it easily meets its second quarter earnings target without any additional increase in sales.

Workflow Auditing: Rhone's internal controls require its controller and assistant controller to review and approve the draft financial statements at the end of each period before they are certified by the CEO and CFO and filed with the SEC. In this case, Carlos unilaterally changes the accounting treatment for the sample parts and senior management approves the statements without comment. Therefore, a quarterly workflow audit does not reveal any process violations.

Financial Analytics: However, a more detailed audit using discovery-driven OLAP analytics would uncover accounting irregularities and suggest deficiencies in the internal controls. This audit would reveal a significant decrease in per-unit cost in the second quarter and a large increase in capital expenses. Also, cube analysis of the data would show that changes in contribution to profit from the new parts are disproportionate to the small increase in sales for those products. These anomalies could be uncovered by specific SQL queries or existing hypothesis-driven OLAP techniques only if the auditor had an idea of where to search for the anomalies. On the other hand, if there are nearly infinite potential cube views, the discovery-driven methods used by the financial results generator, as per the present invention, are more proficient in uncovering such anomalies.

### 3) Compliance in Non-Routine Transactions

Another important requirement of an internal control system is the ability to handle non-routine transactions. This is particularly difficult for an automated system given that the transaction-control workflows are not specified ahead of time. Following are two scenarios describing non-routine transactions that use improper accounting methods to inflate earnings.

Hidden Debt Transaction:—Fred is Rhone's Chief Financial Officer. During the third quarter of Rhone's fiscal year, Fred is approached by Ziske Auto Racing Company with a proposal to develop a series of high-end auto racing parts. Fred assigns a finance department team to perform due diligence on the transaction. The team determines that the proposed venture is very risky, but will yield high returns if it can establish a foothold in this niche market.

Fred is interested in this venture, but does not want Rhone to lose its high debt rating by incurring additional debt. Thus, he structures a joint venture, called Fastlane, in which Rhone and Ziske each invest $5 million in company stock in exchange for a limited partnership interest. The general partner is FS Partners, LLC, which lists Adam, Rhone's assistant CFO, as its sole director. Adam invests $200,000 in Fastlane in exchange for a 4% general partnership interest. Fastlane borrows $10 million from Carnegie Bank, secured by the Rhone and Ziske stock.

The structure of this transaction allows Rhone to invest in a high-risk, high-return venture without expending any cash or incurring additional debt on its balance sheet.

This transaction is unlawful because it hides debt in a joint venture that should be aggregated with Rhone's financial statements, allowing Rhone to hide debt off of its balance sheet. To qualify for non-aggregation and keep such ventures off the balance sheet, accounting rules require the joint venture to be an arms-length transaction, in which a non-related general partner must invest at least 3% of the funds.

Workflow Auditing: Because this is a non-routine transaction, Rhone has not prescribed its transaction-control workflow as part of its internal controls. However, Rhone should have sufficient separation of duty and authorization constraints for all transactions of a certain magnitude to ensure that they are thoroughly reviewed before being executed.

Rhone could require that all transactions exceeding $1 million in value must have (i) comfort letters from outside counsel and auditors; (ii) informed consent of the CEO and Board after reviewing transaction documentation and attorney and auditor letters; (iii) approval of an executive from a different department before funding the deal; and (iv) electronically signed verifications of approvals.

An audit of the workflows in this transaction would reveal that it was initiated by Fred, approved by the Board and CEO without any indication of document review, and funded by the signatures of Fred and the assistant CFO, Adam. Comparing this past workflow to the transaction-control workflow for transactions exceeding $1 million would reveal all of the ways in which this transaction is non-compliant.

If the Board later became suspicious of Fred, they could use query-based auditing to search transactions in which he participated. An auditor could request an audit trail of all transactions above $100,000 that were initiated by Fred within a certain time period. If the Board suspects collusion between Fred and Adam, the auditor could request an audit of all transactions containing approvals of Fred and Adam. Because all activity logs are kept in the database, various audit queries can help investigate suspected improprieties and evaluate the effectiveness of internal controls

Active Enforcement: Rhone could also have active enforcement controls in place to prevent the transfer of the $5 million investment from its treasury accounts pending recognition of both comfort letters and the required electronic signatures of the CEO, the secretary of the Board, and another executive officer.

Hedging Transaction:—During the fourth quarter, Fred worries that Rhone will not reach analysts' earnings estimates, which would adversely affect the price of Rhone's stock and the value of his stock options. Fred notices that Rhone has $3.5 million worth of unrealized gains from its investment in BioLabs, a rapidly-growing pharmaceutical research company. However, accounting rules prevent Rhone from recognizing these gains as earnings.

Fred designs a transaction to hedge the risk of losses on BioLabs, reasoning that such a hedge would allow Rhone to recognize the unrealized gains. Fred transfers $1 million worth of Rhone stock to Fastlane, with the restriction that Fastlane may not sell the stock for two years. In exchange, Rhone receives a put option on BioLabs stock, which allows Rhone to sell the stock to Fastlane, at a fixed price (current market value) at any time over the next two years. After completing these transactions, Fred instructs Rhone's controller to reflect the $3.5 million in unrealized gains as earnings. As a result, Rhone beats earnings estimates for the year and its stock price rises.

This transaction is unlawful because it uses a purported hedge to reflect unrealized capital gains as income, in violation of accounting rules. Further, this is not an actual hedge because: (i) Fastlane, LP is controlled and largely funded by Rhone; and (ii) if BioLabs stock decreases in price, Fastlane may be unable to fund the put option by purchasing the BioLabs stock from Rhone at the strike price.

Workflow Auditing: Although this is an atypical transaction, it should be subject to general internal controls that would prevent execution of this type of fraudulent transaction. In this case, the transaction involves a $1 million stock transfer from Rhone to Fastlane. This should trigger the same authorization and separation of duty constraints as referenced in the Hidden Debt Transaction scenario above. Thus, a workflow audit should reveal whether Fred obtained the required authorizations prior to executing the deal, and if so, who approved it.

Active Enforcement: Similarly, effective active enforcement should prevent Rhone from transferring stock to Fastlane without satisfying required controls. For example, active constraints could prevent Fred from executing the stock transfer to Fastlane pending another executive's approval by electronic signature.

Financial Analytics: OLAP analytics might also be useful to uncover anomalies to suggest that the $3.5 million in earnings was manufactured. For example, they would reveal that Rhone experienced a $3.5 million increase in earnings from investment without a corresponding net return from sales of capital assets. Of course, these anomalies may be manually detected in a small company, but in a large company with many complex financial transactions, discovery-driven OLAP would help to isolate suspicious changes in income statement figures, for instance, not supported by corresponding changes in underlying financial data.

Additionally, the present invention provides for an article of manufacture comprising computer readable program code contained within implementing one or more modules to automate real-time enforcement, modeling and auditing of internal controls over financial reporting. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for:
(a) aiding in logging past transaction activity executions for workflows;
(b) mining logs of the past transaction activity executions to reconstruct past workflows using reconstruction rules;
(c) modeling at least one transaction-control workflow using the reconstructed past workflows as a baseline;
(d) aiding in enforcing policy-based constraints to ensure that each of the past transaction activity executions complies with the at least one transaction-control workflow; and
(e) comparing the reconstructed past workflows with the at least one transaction-control workflow to identify violations to audit constraints

### CONCLUSION

A system and method has been shown in the above embodiments for the effective implementation of a system for automating Sarbanes-Oxley internal controls. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, specific computing hardware, type of database to store activity logs, type of middleware component extensions to intercept workflow activities, techniques used for comparing transaction-control and reconstructed past workflows, or type of query language used to specify query based auditing constraints.

We claim:

1. A computer-based system to automate modeling and auditing of internal controls over financial reporting, said system comprising:
a workflow modeling component to mine logs of past transaction activity executions to reconstruct past workflows using reconstruction rules, said reconstructed past workflows used as a baseline to model at least one transaction-control workflow; and
a workflow auditing component to compare said reconstructed past workflows with said at least one transaction-control workflow to determine compliance with said internal controls.

2. A computer-based system to automate modeling and auditing of internal controls over financial reporting, as per claim 1, wherein said internal controls are defined by Sarbanes-Oxley regulations.

3. A computer-based system to automate modeling and auditing of internal controls over financial reporting, as per claim 1, wherein said workflow auditing component further performs query-based auditing to identify instances of said reconstructed past workflows that violate audit constraints.

4. A computer-based system to automate modeling and auditing of internal controls over financial reporting, as per claim 1, wherein said system further comprises a workflow active enforcement component that compares said past transaction activity executions with said at least one transaction-control workflow to identify exceptions in real time.

5. A computer-based system to automate modeling and auditing of internal controls over financial reporting, as per claim 1, wherein said at least one transaction-control workflow is compiled and stored for auditing purposes.

6. A computer-based system to automate modeling and auditing of internal controls over financial reporting, as per claim 1, wherein said past transaction activity executions are intercepted by middleware component extensions, said middleware component extensions comprising any of the following: containers hosting executable activities in application server environments, extensions in system management environments and policy annotations in web service environments.

7. A computer-based system to automate modeling and auditing of internal controls over financial reporting, as per claim 1, wherein said past transaction activity executions comprise controls over any of the following: initiating, authorizing, recording, processing, and reporting significant accounts, disclosures and assertions in financial statements and said logs of past transaction activity executions comprise at least the following: identity of a person performing an activity, and date and time of activity execution.

8. A computer-based system to automate modeling and auditing of internal controls over financial reporting, as per claim 1, wherein said reconstruction rules assign individual activities of said past transaction activity executions to said reconstructed past workflows.

9. A computer-based system to automate modeling and auditing of internal controls over financial reporting, as per claim 1, wherein said system further comprises a financial analytics component to identify financial anomalies by discovery-driven OLAP analysis.

10. A computer-based system to automate modeling and auditing of internal controls over financial reporting, as per claim 9, wherein said financial analytics component further provides explanations for said identified financial anomalies.

11. A computer-based system to automate real-time enforcement, modeling and auditing of internal controls over financial reporting, said system comprising:
a workflow modeling component to mine logs of past transaction activity executions to reconstruct past workflows using reconstruction rules, said reconstructed past workflows used as a baseline to model at least one transaction-control workflow;
a workflow auditing component to compare said reconstructed past workflows with said at least one transaction-control workflow to identify violations to audit constraints;
a workflow active enforcement component to compare said past transaction activity executions with said at least one transaction-control workflow to identify exceptions in real time; and
wherein said identification of violations to audit constraints and said identification of exceptions in real-time determine compliance with said internal controls.

12. A computer-based system to automate real-time enforcement, modeling and auditing of internal controls over financial reporting, as per claim 11, wherein said internal controls are defined by Sarbanes-Oxley regulations.

13. A computer-based system to automate real-time enforcement, modeling and auditing of internal controls over financial reporting, as per claim 11, wherein said workflow auditing component further performs query-based auditing to identify instances of said reconstructed past workflows that violate said audit constraints.

14. A computer-based system to automate real-time enforcement, modeling and auditing of internal controls over financial reporting, as per claim 11, wherein said system further comprises a financial analytics component to identify financial anomalies by discovery-driven OLAP analysis.

15. A computer-based system to automate real-time enforcement, modeling and auditing of internal controls over financial reporting, as per claim 14, wherein said financial analytics component further provides explanations for said identified financial anomalies.

16. A computer-based method to automate real-time enforcement, modeling and auditing of internal controls over financial reporting, said method comprising:
(a) logging past transaction activity executions for workflows;
(b) mining logs of said past transaction activity executions to reconstruct past workflows using reconstruction rules;
(c) modeling at least one transaction-control workflow using said reconstructed past workflows as a baseline;
(d) enforcing policy-based constraints to ensure that each of said past transaction activity executions complies with said at least one transaction-control workflow;
(e) comparing said reconstructed past workflows with said at least one transaction-control workflow to identify violations to audit constraints; and
wherein said steps (d) and (e) determine compliance with said internal controls.

17. A computer-based method to automate real-time enforcement, modeling and auditing of internal controls over financial reporting, as per claim 16, wherein said internal controls are defined by Sarbanes-Oxley regulations.

18. A computer-based method to automate real-time enforcement, modeling and auditing of internal controls over financial reporting, as per claim 16, wherein said method further comprises the step of: identifying financial anomalies by discovery-driven OLAP analysis.

19. A computer-based method to automate real-time enforcement, modeling and auditing of internal controls over financial reporting, as per claim 18, wherein said OLAP analysis further provides explanations for said identified financial anomalies.

20. A computer-based method to automate real-time enforcement, modeling and auditing of internal controls over financial reporting, as per claim 16, wherein said policy-based constraints either prevent completion of non-compliant transactions or allow completion of non-complaint transactions while recording violations to said at least one transaction-control workflow.

21. A computer-based method to automate real-time enforcement, modeling and auditing of internal controls over financial reporting, as per claim 16, wherein said method further comprises the step of: performing query-based auditing to identify instances of said reconstructed past workflows that violate said audit constraints.

22. An article of manufacture comprising a computer usable medium having computer readable program code embodied therein to automate real-time enforcement, modeling and auditing of internal controls over financial reporting, said medium comprising:
(a) computer readable program code aiding in logging past transaction activity executions for workflows;
(b) computer readable program code mining logs of said past transaction activity executions to reconstruct past workflows using reconstruction rules;
(c) computer readable program code modeling at least one transaction-control workflow using said reconstructed past workflows as a baseline;
(d) computer readable program code aiding in enforcing policy-based constraints to ensure that each of said past transaction activity executions complies with said at least one transaction-control workflow;
(e) computer readable program code comparing said reconstructed past workflows with said at least one required workflow to identify violations to audit constraints; and
wherein compliance with said internal controls is determined based on said enforcement of policy-based constraints in (d) and said identification of violations to audit constraints in (e).

23. An article of manufacture comprising a computer usable medium having computer readable program code embodied therein to automate real-time enforcement, modeling and auditing of internal controls over financial reporting, as per claim 22, said medium further comprising:
computer readable program code performing query-based auditing to identify instances of said reconstructed past workflows that violate said audit constraints; and
computer readable program code identifying financial anomalies by discovery-driven OLAP analysis.
